(19) United States
(12) Patent Application Publication
(10) Pub. No.: US 2008/0086412 A1
(43) Pub. Date: Apr. 10, 2008

(54) PAYMENT SYSTEM AND METHODS

(76) Inventors: Joseph R. Randazza, Boca Raton, FL (US); Danilo Portal, Miramar, FL (US)

Correspondence Address: JEROME D. JACKSON (JACKSON PATENT LAW OFFICE), 211 N. UNION STREET, SUITE 100, ALEXANDRIA, VA, 22314, US

(21) Appl. No.: 11/865,128

(22) Filed: Oct. 1, 2007

Related U.S. Application Data
(60) Provisional application No. 60/828,650, filed on Oct. 8, 2006.

(51) Int. Cl. G06Q 20/00

(52) U.S. Cl. 705/39; 235/379; 705/17

(57) ABSTRACT

Disclosed are methods for a system having a payment switch and a retailer. In a plurality of cards, a first signal corresponds to a signal common to the plurality of cards, and there is a second signal on a first card in the plurality of cards. The method includes receiving the second signal from the point of sale; accessing the bank account, by using the first signal and the signal received in the previous step; responsive to a failure to withdraw funds from the bank account, accessing the bank account to withdraw a fee; and making an accounting system entry corresponding to a first amount the first amount being a portion of the fee owed by the first business entity to the retailer.

### BACKGROUND OF THE INVENTION

This Application claims the benefit of U.S. application Ser. No. 60/828,650 of JOSEPH R. RANDAZZA AND DANILO PORTAL Oct. 8, 2006 for PAYMENT SYSTEMS AND METHODS, the contents of which are herein incorporated by reference.

1. Field of the Invention

This invention relates generally to payment systems and methods and, more particularly, to payment systems and methods deployed in a retail environment.

### SUMMARY OF THE INVENTION

According to an aspect of the present invention, there is a method for a system having a first business entity and a retailer, the first business entity and the retailer being non-affiliated; a plurality of persons; a plurality of cards; a first signal corresponding to a signal common to the plurality of cards; a second signal on a first card in the plurality of cards; information corresponding to an bank account; and a point of sale. The method comprises receiving the second signal from the point of sale; accessing the bank account, by using the first signal and the signal received in the previous step; responsive to a failure to withdraw funds from the bank account, accessing the bank account to withdraw a fee; and in an accounting system, making an entry corresponding to a first amount, the first amount being a portion of the fee owed by the first business entity to the retailer.

According to another aspect of the present invention, there is a method for a system having a payment switch and a retailer, the payment switch and the retailer being non-affiliated; a plurality of persons; a plurality of cards; a first signal corresponding to a signal common to the plurality of cards; a second signal on a first card in the plurality of cards. The method comprises receiving the second signal from a point of sale; accessing a bank account, by using the first signal and the signal received in the previous step; responsive to a failure to withdraw funds from the bank account, accessing the bank account to withdraw an NSF fee; and in an accounting system, making an entry corresponding to a first amount, the first amount being a portion of the fee owed by the owner of the payment switch to the retailer.

According to yet another aspect of the present invention, there is a financial system for a system having a first business entity and a retailer, the first business entity and the retailer being non-affiliated; a plurality of persons; a plurality of cards; a first signal corresponding to a signal common to the plurality of cards; a second signal on a first card in the plurality of cards; information corresponding to an bank account; and a point of sale. The financial system comprises a receiver that acts to receive the second signal from the point of sale; circuitry that accesses the bank account, by using the first signal and the signal received by the receiver; circuitry that detects a failure to withdraw funds from the bank account, and accesses the bank account to withdraw a fee; and circuitry that writes an entry into an accounting system, the entry corresponding to a first amount, the first amount being a portion of the fee owed by the first business entity to the retailer.

According to yet another aspect of the present invention, there is a financial system for a system having a payment switch and a retailer, the payment switch and the retailer being non-affiliated; a plurality of persons; a plurality of cards; a first signal corresponding to a signal common to the plurality of cards; a second signal on a first card in the plurality of cards. The financial system comprises means for receiving the second signal from a point of sale; means for accessing a bank account, by using the first signal and the signal received by the means for receiving; means, responsive to a failure to withdraw funds from the bank account, for accessing the bank account to withdraw an NSF fee; and in an accounting system, means for making an entry corresponding to a first amount, the first amount being a portion of the fee owed by the owner of the payment switch to the retailer.

### BRIEF DESCRIPTION OF THE DRAWINGS

References are made to the following text taken in connection with the accompanying drawings, in which:

FIG. 1 shows a retail system according to a first exemplary embodiment of the present invention.

FIGS. 2A and 2B show another aspect of the first exemplary system.

FIGS. 3A and 3B show a driver's license card in the first exemplary system.

FIGS. 4A, 4B, 4C, and 4D are a flowchart of a process performed in the first exemplary system.

FIG. 5 shows another aspect of the exemplary system.

FIG. 6 shows another aspect of the exemplary system.

FIGS. 7A, 7B, and 7C show a retail grocery store in the first exemplary system.

FIG. 8 is a diagram showing transaction flows in the first exemplary system.

FIG. 9 shows another retail site in the first exemplary system.

FIG. 10 is a representation of a table in a database in the first exemplary system.

FIG. 11 is a diagram emphasizing certain features of the circuitry shown in FIG. 8.

The accompanying drawings which are incorporated in and which constitute a part of this specification, illustrate embodiments of the invention and, together with the description, explain the principles of the invention, and additional advantages thereof. Certain drawings are not necessarily to scale, and certain features may be shown larger than relative actual size to facilitate a more clear description of those features. Throughout the drawings, corresponding elements are labeled with corresponding reference numbers.

### DETAILED DESCRIPTION OF EXEMPLARY EMBODIMENTS

### First Exemplary Embodiment

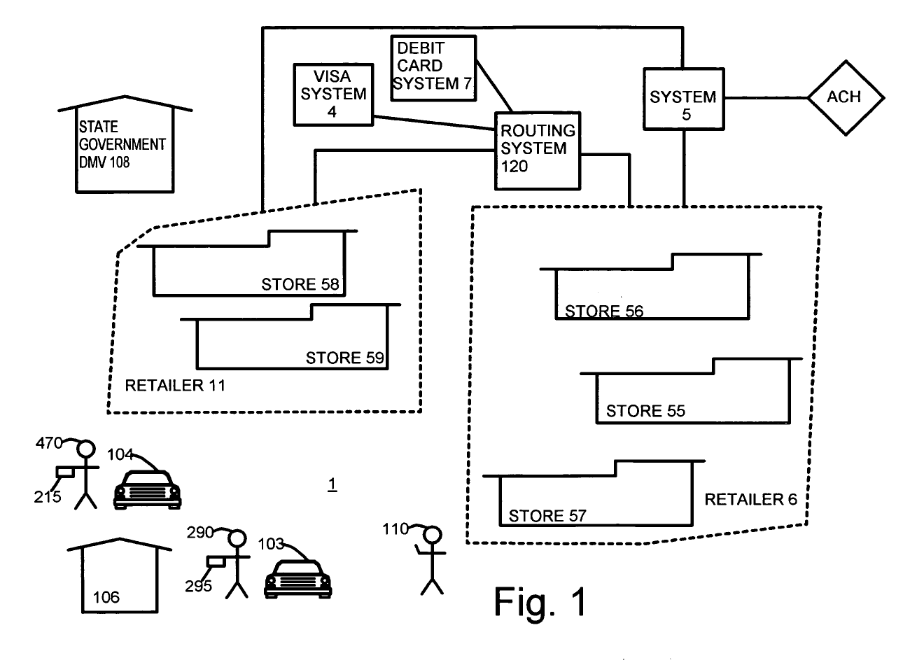

FIG. 1 shows exemplary system 1 according to a preferred embodiment of the present invention. System 1 includes multiple persons, such as person 290 and person 470. System 1 also includes a plurality of vehicles, such as automobile 103 owned by person 290 and automobile 104 owned by person 470. Person 290 operates automobile 103 to travel from her home 106 to various locations, such as her place of employment, and store 55 in retailer 6. Person 290 carries a driver's license card 295 evidencing a license to operate a vehicle such as automobile 103. Person 470 operates automobile 104 to travel from her home to various locations, such as store 55 in retailer 6. Person 470 carries a driver's license card 215 evidencing a license to operate a vehicle such as automobile 104.

These licenses and license cards 215 and 295 license were issued under the authority of the Florida Department of Motor Vehicles (DMV) by Motor Vehicle Department 108, which is a part of the Florida State Government. Occasionally, persons 290 and 470 must display their driver's license cards to state officials, such as policeman 110 to prove they are authorized to operate an automobile.

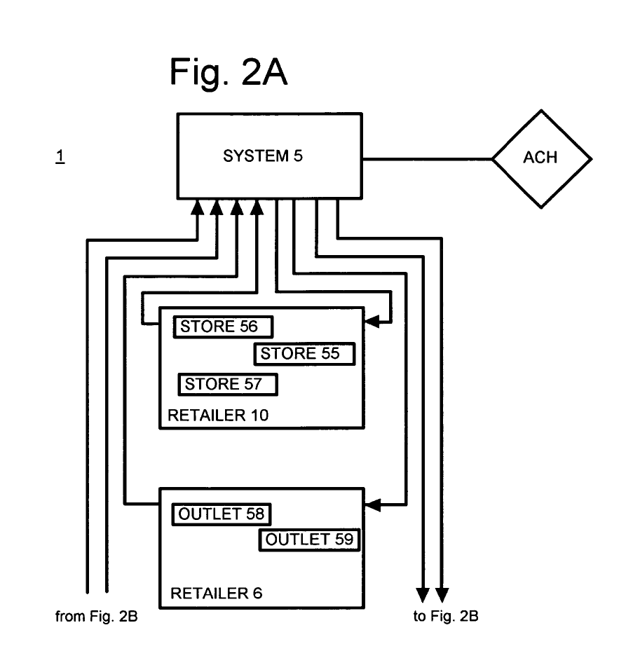

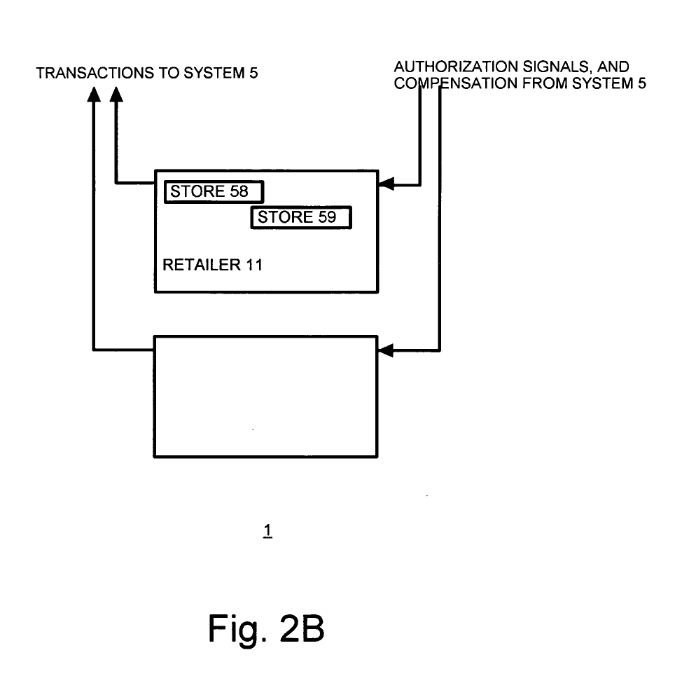

FIGS. 2A and 2B emphasize other aspects of System 1. System 1 includes system 5, communicating with retailer 6, retailer 10, retailer 11, and other retailers, via circuitry at retail sites, as described in more detail below. System 5, located in Reston, Va., receives signals from the retailers, to validate customer authorization at the time of a retail transaction, and to debit a customer bank account later. A signal from a retailer to system 5 is represented by a directed line going from the retailer to system 5; and a signal from system 5 to a retailer is represented by a directed line going from system 5 to the retailer.

In response to a signal from retailer 6, for example, system 5 conditionally generates a transaction authorization signal.

In response to the transaction authorization signal from system 5, retailer 6 allows a customer transaction to proceed.

System 5 is owned and operated by a private entity that is under the general control of neither the Florida State Government nor the Virginia State Government. Of course the private entity that owns and controls system 5 may have certain statutory, regulatory, contractual, or common law obligations to these state governments, as any persons resident in a state would have.

The owner of system 5 and the owner of retailer 11 are non-affiliated, meaning that they are not affiliates with respect to each other. Is this patent application, concerns are affiliates of each other when one concern controls or has the power to control the other, or a third party or parties controls or has the power to control both. Power to control is described in Section 121 of the U.S. regulations of the Small Business Administration.

The owner of system 5 and the owner of retailer 6 are non-affiliated.

The owner of system 5 and the owner of retailer 10 are non-affiliated.

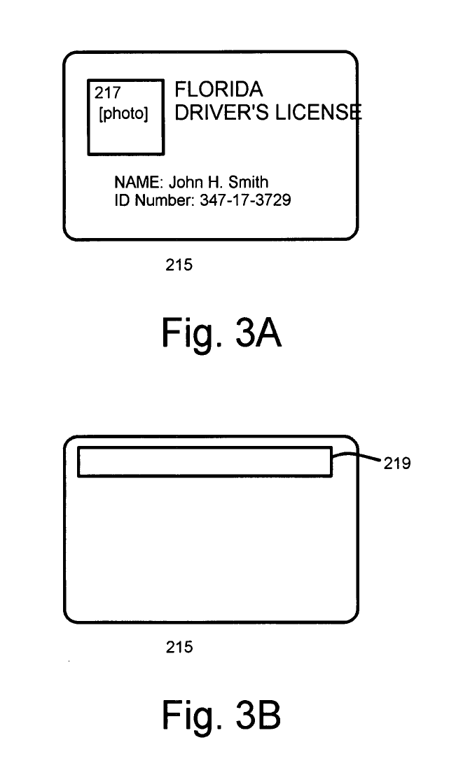

FIG. 3A shows a front, plan view of card 215 carried by person 470, who is a customer in system 1, and FIG. 3B shows a back, plan view of card 215. In this example, card 215 is a state-issued driver's license including a photograph 217 of person 470, and magnetic stripe 219 storing the ID number of person 470 and other information on the reverse side. Track 2 of stripe 219 also stores the IIN number 636010, indicating the jurisdiction of Florida, in accordance with International Standard ISO 7812.

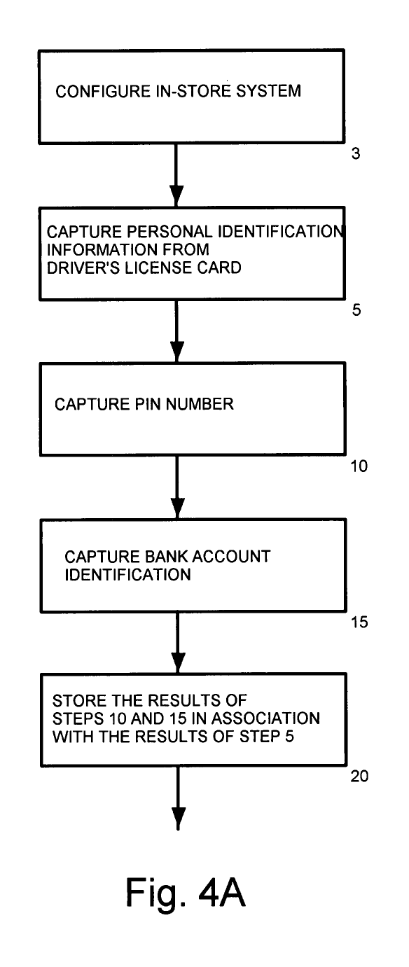

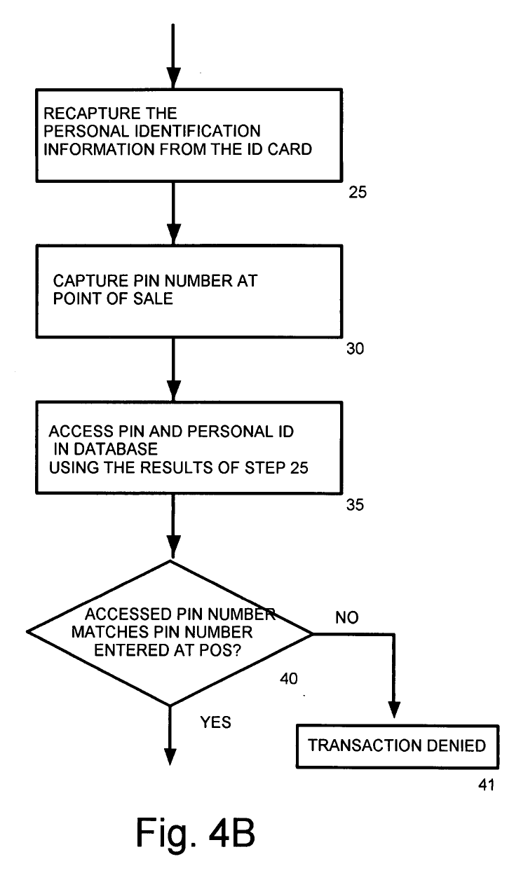

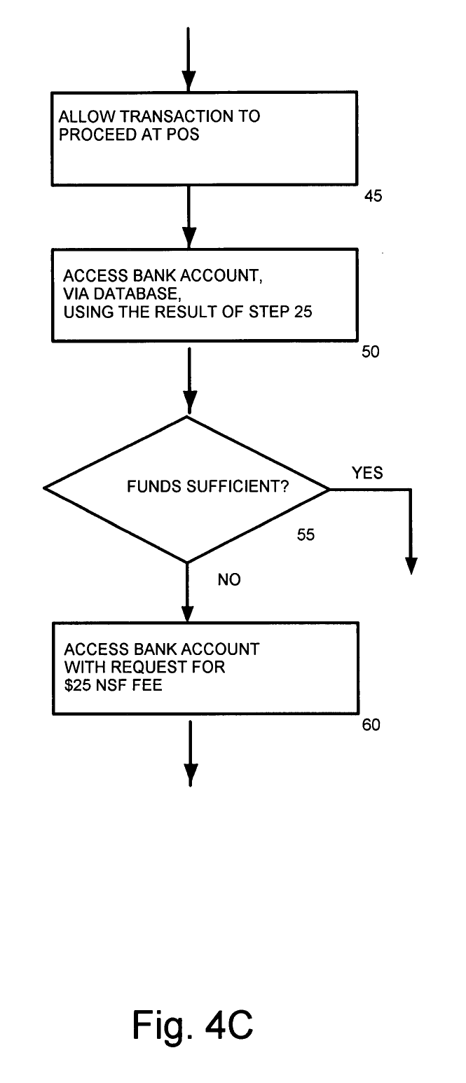

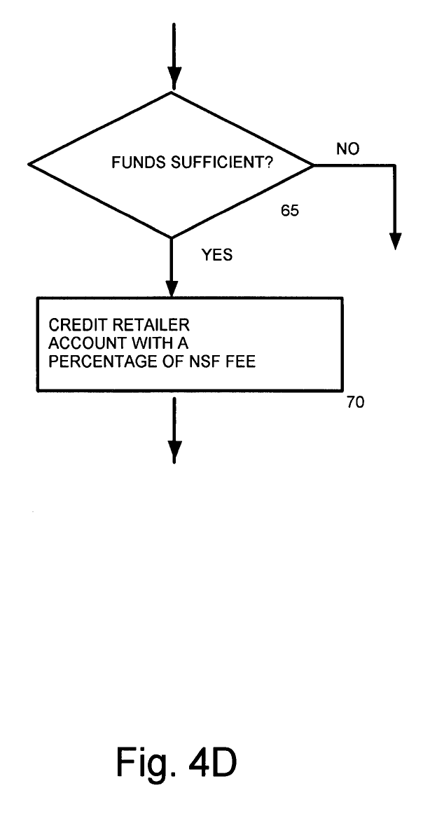

FIGS. 4A, 4B, and 4C show a process performed by circuitry in system 1. Steps 5, 10, and 15 are performed for multiple persons, in a store of a retailer, such as retailer 10. In order to enroll in the program, the customer is processed at the retailer customer service area, where the magnetic stripe 219 of card 215 is scanned (step 5), a personal identification number (PIN) entry is received from the consumer into the terminal (step 10), and a personal check is scanned (step 15). The collection of the card identification number, PIN, the bank routing and bank account number read from the check, then becomes part of transmitted packet to system 5, in which they are stored in association in a database (step 20). The method and protocol for this transmission is uses ISO 8583 or Web-based URLs via a Secure Socket Layer (SSL) link.

Consumer 470 acts as an ACH “Receiver” to authorize a debit towards her account 471 in bank 178.

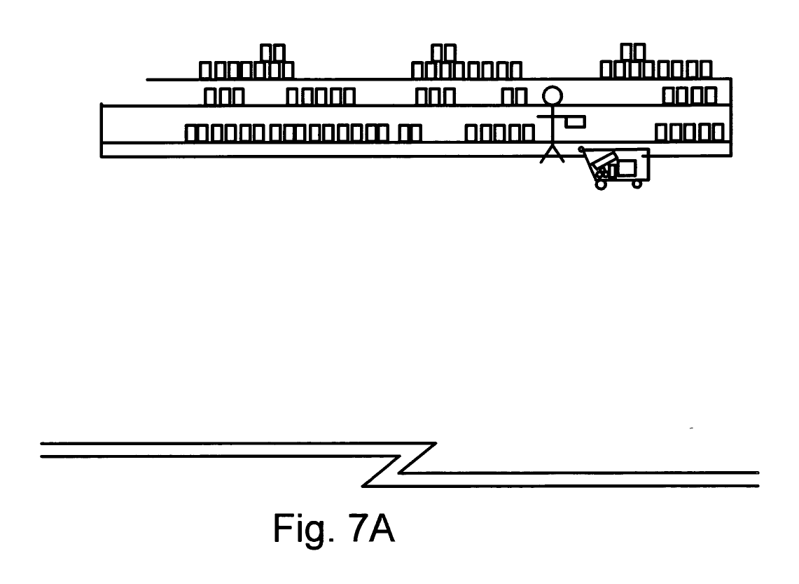

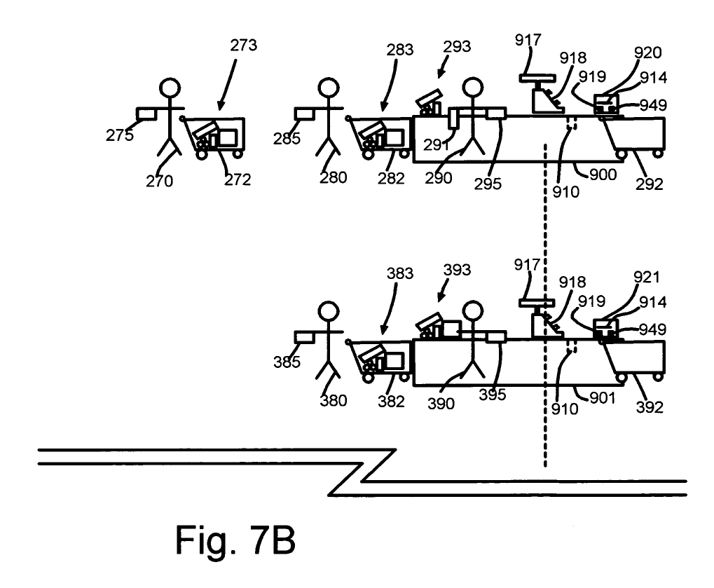

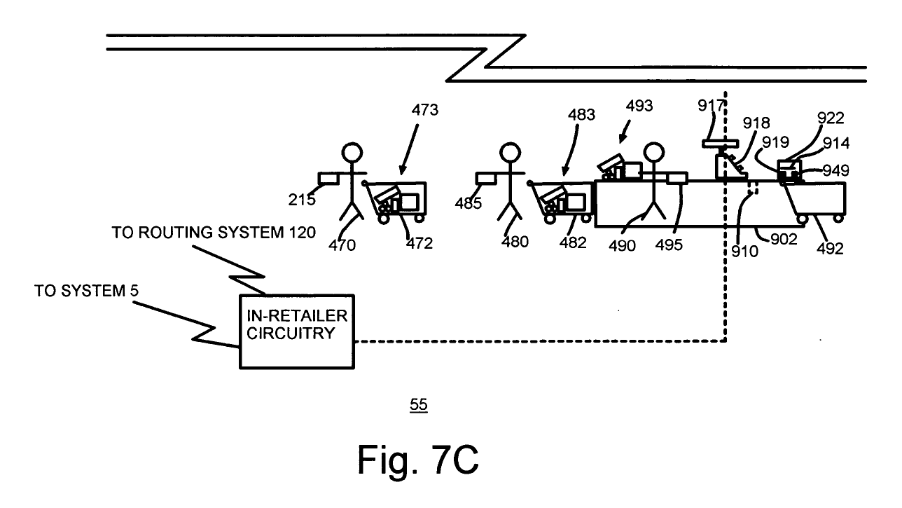

FIG. 7A, 7B, and 7C show a context in which subsequent steps of the flow chart of FIGS. 4A, 4B, and 4C are performed. FIGS. 7A, 7B, and 7C are each a partial view of store 55 in retailer 10. Store 55 has a plurality of product areas, each corresponding to a respective product, and checkout stations 900, 901, and 902. Each checkout station includes a bar code reader that detects an optical (electromagnetic) signal reflected from a bar code, and a magnetic stripe reader that scans a magnetic card. Checkout station 900 includes payment terminal 920 having a card interface slot 914, checkout station 901 includes payment terminal 921 having a card interface slot 914, and checkout station 902 includes payment terminal 922 having a card interface slot 914. Each payment terminal includes a button 919 labeled “CREDIT” and a button 949 labeled “DEBIT”.

Upon completion of shopping, each customer brings selected products from the shelves to checkout station 900, 901, or 902.

Each customer presents her customer card. In this example, customer 490 presents credit card 495, which is associated with an installment payment account of customer 490. Customer 480 presents debit card 485, which is associated with a demand account of customer 480. Customer 470 presents system-5-registered driver's license card 215.

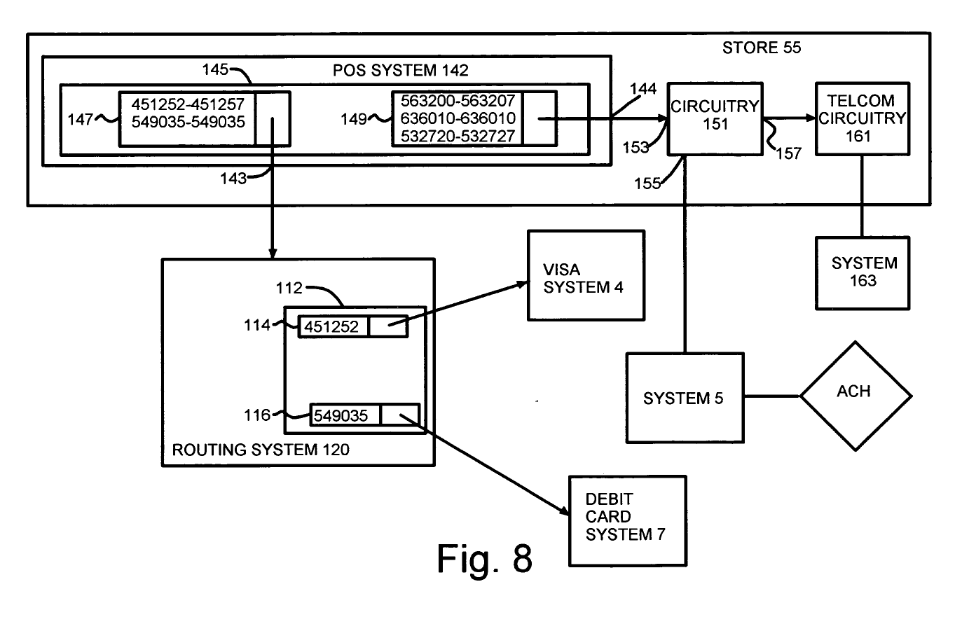

Customer 490 completes the purchase of her selected products 493 by transferring products 493 from her cart 492 to station 902, and by presenting card 495. A checkout clerk (not shown) scans each selected product past bar code reader 910, or enters the product selection information manually via keyboard 918. Checkout station 902 determines a total amount due and prints the total amount due on display 917. Customer 490 activates credit button 919. In response to the activation of credit button 919, circuitry in retailer 10 transmits the account number of card 495 to a credit/debit card authorization provider, such as VISA system 4 shown in FIG. 8, via routing system 120.

Routing system 120 has been configured, in accordance with a network address, or network position, of systems 4 and 7, so that certain signals will be sent to systems 4 and 7, as described in more detail below.

In this Patent Application, the word circuitry encompasses dedicated hardware, and/or programmable hardware, such as a CPU or reconfigurable logic array, in combination with programming data, such as sequentially fetched CPU instructions or programming data for a reconfigurable array.

Customer 480 completes the purchase of her selected products 483 by transferring products 483 from her cart 482 to station 902, and by presenting card 485. The checkout clerk scans selected products past bar code reader 910. Checkout station 902 determines a total amount due and prints the total amount due on display 917. Customer 480 activates debit button 949. In response to the activation of debit button 949, circuitry in payment terminal 922 prompts customer 480 to enter a PIN into a keypad on terminal 922. Terminal 922 then applies an encryption key to the entered PIN, to generate an encrypted PIN. Circuitry in retailer 10 then transmits the encrypted PIN and the account number of card 485 to a credit/debit card authorization provider, such as Honor, Star, or Interlink shown in FIG. 8, via routing system 120.

Customer 470 completes the purchase of her selected products 473 by transferring products 473 from her cart 472 to station 902, and by presenting driver's license card 215. The checkout clerk scans selected products past bar code reader 910. Checkout station 902 determines a total amount due and prints the total amount due on display 917. Station 902 reads the ID information of person 470 from card 215, and reads the Issuer Identification Number, 636010, indicating the State of Florida, from driver's license card 215. (step 25) (FIG. 3B). Customer 470 or the clerk activates credit button 919. In response to the activation of credit button 919, circuitry 151 (FIG. 8) in retailer 10 sends a signal to terminal 922, causing terminal 922 to prompt customer 470 to enter a PIN into a keypad on terminal 922. Terminal 922 then sends the entered PIN to circuitry 151, without applying the encryption key to the entered PIN. Circuitry 151 then applies an encryption key to the PIN received from terminal 922, to generate an encrypted PIN. Circuitry in retailer 10 then transmits the encrypted PIN and the license identification of driver's license card 215 to system 5, via circuitry 151. At this time the circuitry also transmits retailer ID, store ID date, time, lane ID, cashier ID, transaction amount.

Circuitry in system 5 uses the ID number of the card, transmitted by the server, to access the associated PIN stored in the database. (step 35). System 5 thus compares the PIN, transmitted by the store server, to the PIN read from the database. (step 40). Depending upon the result of step 40, system 5 conditionally responds to the store server with a card-authorized signal, causing station 902 to allow customer 470 to carry away products 473. (step 45).

Otherwise system 5 sends a card-not-authorized signal to the store server.

Step 40 may also include real-time communication to an external database to validate the card against a negative check database.

It is presently preferred that system 5 validate incoming transactions and respond back to the store within several seconds.

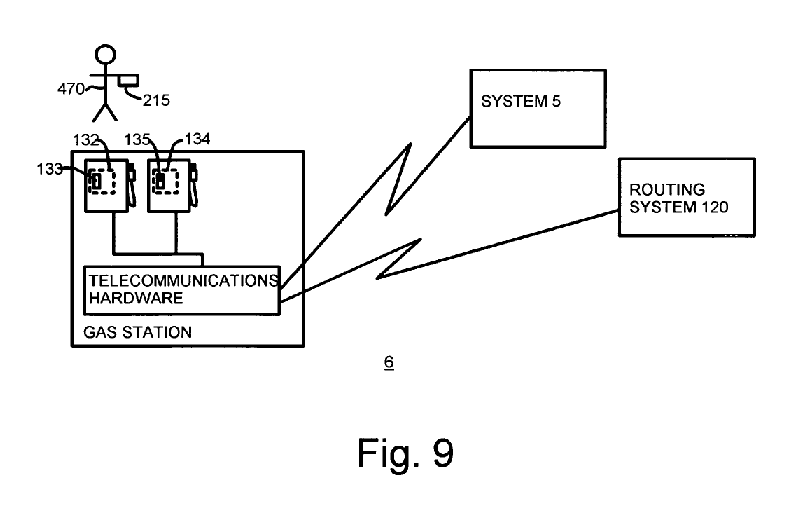

FIG. 9 shows retailer 6 in system 1 in more detail. Retailer 6 is a gas station. The gas station includes gas pump point of scale (POS) terminal 132 with card interface 133, gas pump POS terminal 134 with card interface 135, telecommunications circuitry, and a network cable coupling POS terminal 132, POS terminal 134 and telecommunications circuitry together.

Customer 470 buys gas by presenting card 215, either at the payment terminal 132 or elsewhere in the gas station. The gas station reads the ID information from card 215.

Circuitry in system 5 uses the ID number of the card, transmitted by circuitry in retailer 6, to access the associated PIN stored in the database. System 5 conditionally responds to the server in retailer 6 with a card-authorized signal, or a card-not-authorized signal. If the server receives a card-authorized signal, the transaction proceeds and the server then transmits a transaction amount to system 5.

Automated Clearing House (ACH) Settlement transmission occurs daily in batch fashion. (step 50). More specifically, system 5 compiles a file at end of day for submission to the ACH services. The required fields that this file contain are: date, time, transaction type, retailer ID, store ID, bank routing #, bank account #, amount of transaction. The specifics and file format is further defined with the ACH processor.

Status from ACH is collected and logged for review.

System 5 receives a return message from the ACH system and determines whether the consumer's account has sufficient funds. (step 55) Depending upon the result of step 55, system 5 again accesses the account, this time with a request for a $25 non-sufficient funds (NSF) fee (step 60). If the NSF fee is received (step 65), system 5 credits the retailer with a percentage of the NSF fee. (Step 70).

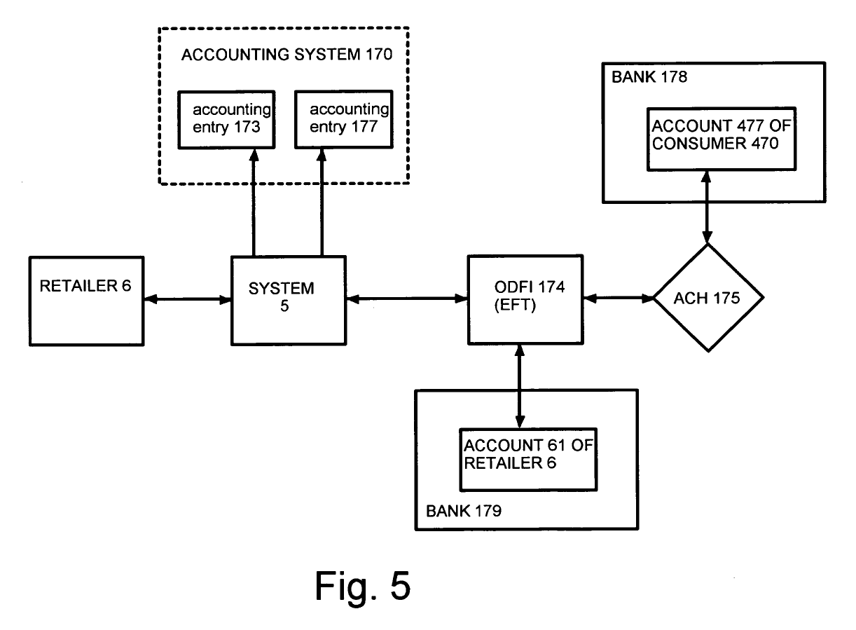

FIG. 5 is a diagram emphasizing other aspects of the exemplary system.

ODFI (Originating Depository Financial Institution) 174 originates a PPD (Prearranged Payment and Deposits) ACH entry at the request of system 5. ODFI 174 sends the PPD entry to the Federal Reserve ACH system 175, which passes the entry to bank 178, which acts as a Receiving Depository Financial Institution (RDFI), where account 477 is issued debit, provided there are sufficient funds. Thus ODFI 174 effects an Electronic Funds Transfer (EFT).

When system 5 settles a transaction by causing the transfer of funds from account 477 of consumer 470 to account 61 of retailer 6, system 5 makes an entry in accounting system 170, to effectively increment an amount 173 owed by retailer 6 to the owner of system 5. This amount 173 is a service fee for settling the transaction.

Bank 178 may reject the PPD transaction and return it to ODFI 174 with an NSF message. ODFI 174 then echoes a corresponding message back to system 5. System 5 receiving a return of the PPD entry may re-present the PPD via ODFI 174.

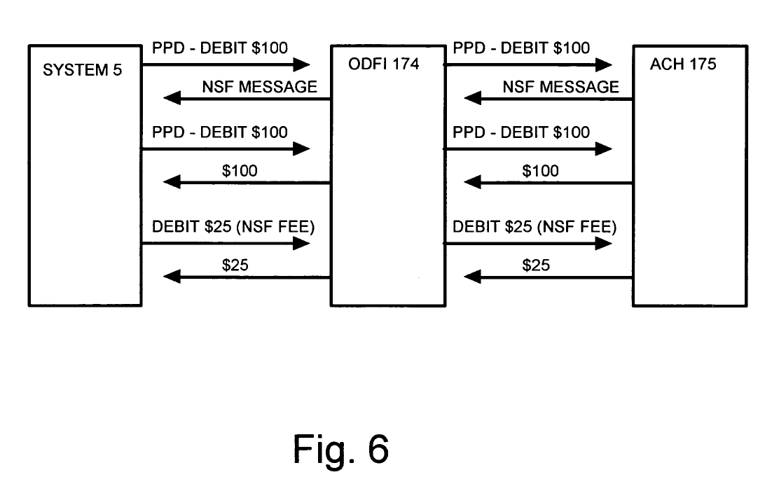

FIG. 6 shows a messaging between system 5 and the ACH system. As part of a batch settlement message, system 5 requests an amount due ($100 in this example) from account 471 of consumer 470, via the ACH system. The system sends an NSF message to indicate to system 5, to indicate that there are insufficient funds in account 471.

Responsive to the NSF message, system 5 re-presents the request, after waiting, for several business days for example. If the re-presentment is successful, system 5 then requests the $25 NSF fee from account 471.

System 5 gives a portion, less than 100%, of the NSF fee to retailer 6. System 5 makes an entry in accounting system 170 to increment an amount 177 to be credited to retailer 6.

There are various ways that system 5 may transfer the amount 177 to retailer 6. For example, system 5 may periodically issue a check to retailer 6 for NSF fees accumulated over an accounting period. Alternatively, for example, system 5 may apply the amount 177 as an offset to amounts owed by retailer 6 to system 5. For example system 5 may apply amounts 177 as an offset to amounts 173.

In summary, an exemplary system accesses the bank account 471, by using an IIN and personal ID number received from a card. Responsive to a failure to withdraw funds from account 471, system 5 accesses account 471 to withdraw an NSF fee. System 5 then generates an accounting entry corresponding to a first amount, the first amount being a portion of the fee owed by system 5 to the retailer 6.

FIG. 8 shows another aspect of the first exemplary system, including circuitry in store 55. Point of Sale (POS) system 142 receives data read from cards presented by customers in store 55. POS system 142 includes data structure 145, accessed by programs in system 142. Data structure 145 allows system 142 to select the path of a card data received from a checkout, as a function of an issuer identification number (IIN) in the card data. POS System 142 may be a Verifone Ruby system, for example, and data structure 145 maps ranges of IIN numbers to a port.

For example, when system 142 receives card data containing an IIN in the range 451252 to 451257, or 549035 to 549035, system 142 accesses IIN ranges 147, to send a transaction request to routing system 120, via port 143 on system 142.

When system 142 receives card data containing an IIN in the range 563200 to 563207, 636010 to 636010, or 532720 to 532727, system 142 accesses IIN ranges 149, to send a transaction request to circuitry 151, via port 144 on system 142.

Routing system 120 includes a data structure 112, accessed by programs in routing system 120. Data structure 112 allows routing system 120 to select the path of a transaction request packet received from a retailer, as a function of a routing field in the packet. The routing field may contain an issuer identification number (IIN). For example, when routing system 120 receives a transaction request packet containing the number 451252 in the routing field, routing system 120 accesses entry 114, to send the packet to system 4 of the VISA Corporation, allowing system 4 to authorize a credit card transaction. When routing system 120 receives a transaction request packet containing the number 549035 in the routing field, routing system 120 accesses entry 116, to send the packet to debit card system 7, allowing system 7 to authorize a debit card transaction.

When circuitry 151 receives a transaction request packet on port 153 of circuitry of 151, circuitry 151 sends a corresponding packet out on port 155 of circuitry 151 if the IIN is 636010, or out on port 157 otherwise.

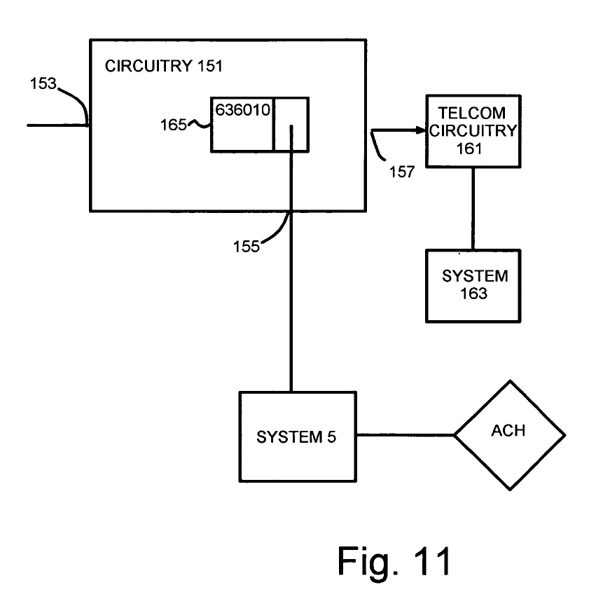

FIG. 11 shows other aspects of circuitry 151 in more detail. Circuitry 151 receives transaction messages, each including an IIN, from POS 142. Circuitry 151 includes data structure 165, accessed by programs in circuitry 151. Data structure 165 allows circuitry 151 to select the path of a transaction message, as a function of an issuer identification number (IIN) in the message.

For example, when circuitry 151 receives a message containing an IIN of 636010, circuitry 151 detects this fact by accessing data structure 165, to send the message to system 5 via port 155. On the other hand, when circuitry receives a message containing an IIN that is not represented in data structure 165, circuitry 151 sends the message out on port 157, to system 163 via telecommunications circuitry 161.

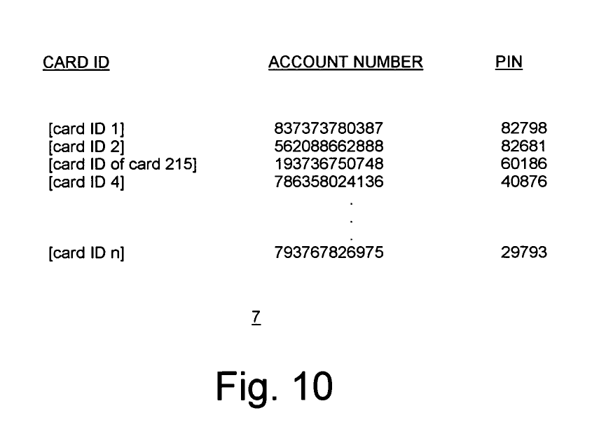

FIG. 10 is a representation of a table 7 in a disk-resident database in system 5. Each row in table 7 is an association between a card ID and other data such as an account number associated with the card ID, and a PIN associated with the account.

The application will have user interface to activate/inactivate/delete and reissue a card. Transaction logging contains detail information for each payment transaction. For example, the detail includes time stamp: store ID: lane ID: cashier ID: card #: payment amount: swiped vs. bar-coded.

In summary, a point-of-sale payment transaction is effected via a State issued motor vehicle driver's license card and a personal identification number (PIN) as a mechanism of payment for a retail store transaction. A process by which a State issued motor vehicle driver's license is effected to identified a consumer for initiating a payment at the Point of Sale, without the use of any other form of payment.

The POS allows the driver's license to be used as a form of payment to debit a consumer checking account or savings account as a electronic fund transfer using the Federal Reserve Automatic Clearing House (ACH) for settlement.

The system utilizes the driver's license card; a PIN for authentication; POS/payment terminal equipment; a communications network to link to retailers POS system to a ACH host processor; a data base with registered consumers banking information; the ACH system for settlement. The system can be used at any retail facility that installs the system. These include Supermarkets, Convenience stores, gas stations, etc.

The system allows the consumer to enroll into this system at a merchant location operated by store personnel, a self-service kiosk, or an interactive voice response telephone enrollment system, for example.

The consumer enrollment process captures information identifying the consumer, to form an electronic record that is stored in a remote or local computer. Once the enrollment is complete, the consumer can use the driver's license to pay for goods and services.

System 1 provides a process mechanism (Enrollment) for linking, the consumer driver's license card, based on national standard, magnetic and 2d format to be scanned or swipe, capturing the content of the magnetic data or the decoded barcode data, using a parsing algorithm that presents the data necessary to build the electronic record required by this system. This includes the driver's license number, date of birth, age, address, state issued, date driver's license is issued, date driver's license expires, gender.

Once the driver's license card information is captured, the consumer is asked to enter a PIN. The PIN is encrypted and made part of the electronic record. Next the consumer is asked to present a blank commercial bank check, this check is scanned by check reader that will capture the image of the check, the bank routing number and the bank account. Once the above process is completed the electronic record is formed and stored in a local or remote computer depending on the merchant network infrastructure.

In accordance with an alternate enrollment process, the consumer enters his driver's license number into the enrollment website or a paper application. Background software, executing in system 5, captures the license number and builds the encoded ID number that is contained in track 2 of the driver's license. This is the number seen by computer systems, which is different than what is printed on the DL card.

For example, for a driver's license having face value ID of “P634-160-55-448-0”, the consumer will enter this number as they see in the front of the card. The data on track 2 of the magnetic strip is 6360101663416055448, wherein 636010 is the IIN number for Florida, 16 represents the decimal value of the letter P in the alphabet, and 63416055448 is the actual number in the font of the card without the last 0. Thus, in this alternate enrollment process, the system reads the enrolled ID and state jurisdiction, such as Florida or Georgia, entered by the consumer, and then builds the encoded ID to match the data in track 2 of the magnetic strip.

Although a driver's license has been depicted as the mechanism to access a consumer account, other mechanisms may be used, such as association membership cards, and retailer-branded cards. There is no restriction on where the cards may be used to effect a retailer transaction. For example, a card branded by retailer X may be used to effect a transaction at retailer Y.

Throughout this Patent Application, certain processing may be depicted in serial, parallel, multiplexed, or other fashion, for ease of description. Actual hardware and software realizations, however, may be varied depending on desired optimizations apparent to one of ordinary skill in the art.

Other systems and options for enrollment and transaction processes may be found in U.S. application Ser. No. 11/692,172 of JOSEPH R. RANDAZZA AND DANILO PORTAL filed Mar. 27, 2007 for PAYMENT SYSTEMS AND METHODS, the contents of which are herein incorporated by reference; U.S. application Ser. No. 11/734,216 of JOSEPH R. RANDAZZA AND DANILO PORTAL filed Apr. 11, 2007 for PAYMENT SYSTEMS AND METHODS, the contents of which are herein incorporated by reference; and U.S. application Ser. No. 11/539,636 of JOSEPH R. RANDAZZA AND DANILO PORTAL Oct. 8, 2006 for PAYMENT SYSTEMS AND METHODS, the contents of which are herein incorporated by reference.

Benefits, other advantages, and solutions to problems have been described above with regard to specific examples. The benefits, advantages, solutions to problems, and any element(s) that may cause any benefit, advantage, or solution to occur or become more pronounced are not critical, required, or essential feature or element of any of the claims.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims. In general, the words “first,” “second,” etc., employed in the claims do not necessarily denote an order.

What is claimed is:

1. A method for a system having a first business entity and a retailer, the first business entity and the retailer being non-affiliated; a plurality of persons; a plurality of cards; a first signal corresponding to a signal common to the plurality of cards; a second signal on a first card in the plurality of cards; information corresponding to an bank account; and a point of sale, the method comprising:
receiving the second signal from the point of sale;
accessing the bank account, by using the first signal and the signal received in the previous step;
responsive to a failure to withdraw funds from the bank account, accessing the bank account to withdraw a fee; and
in an accounting system, making an entry corresponding to a first amount, the first amount being a portion of the fee owed by the first business entity to the retailer.

2. The method of claim 1 wherein accessing the bank account includes receiving the first signal from the first card; and
making a routing decision in the retailer.

3. The method of claim 1 wherein the bank account is a demand account.

4. The method of claim 1 wherein accessing includes accessing via the United States Automated Clearing House (ACH) system.

5. The method of claim 1 wherein the first card is issued by a first state government, and the receiving step is performed in the territory of a second state government.

6. The method of claim 1 wherein the information corresponding to the bank account includes an account number previously presented, to a customer, on a paper statement generated by the financial institution managing the bank account.

7. The method of claim 6 wherein the financial institution is a bank.

8. The method of claim 1 wherein the plurality of cards are issued under authority of a government, each card evidencing a license for a person to operate a vehicle.

9. The method of claim 1 wherein the fee includes a non sufficient funds (NSF) fee allowable within state or federal statutes or regulations.

10. A method for a system having a payment switch and a retailer, the payment switch and the retailer being non-affiliated; a plurality of persons; a plurality of cards; a first signal corresponding to a signal common to the plurality of cards; a second signal on a first card in the plurality of cards, the method comprising:
receiving the second signal from a point of sale;
accessing a bank account, by using the first signal and the signal received in the previous step;
responsive to a failure to withdraw funds from the bank account, accessing the bank account to withdraw an NSF fee; and
in an accounting system, making an entry corresponding to a first amount, the first amount being a portion of the fee owed by the owner of the payment switch to the retailer.

11. A financial system for a system having a first business entity and a retailer the first business entity and the retailer being non-affiliated; a plurality of persons; a plurality of cards; a first signal corresponding to a signal common to the plurality of cards; a second signal on a first card in the plurality of cards; information corresponding to an bank account; and a point of sale, the financial system comprising:
a receiver that acts to receive the second signal from the point of sale;
circuitry that accesses the bank account, by using the first signal and the signal received by the receiver;
circuitry that detects a failure to withdraw funds from the bank account, and accesses the bank account to withdraw a fee; and
circuitry that writes an entry into an accounting system, the entry corresponding to a first amount, the first amount being a portion of the fee owed by the first business entity to the retailer.

12. The financial system of claim 11 wherein the bank account is a demand account.

13. The financial system of claim 11 wherein the circuitry that accesses acts via the United States Automated Clearing House (ACH) system.

14. The financial system of claim 11 wherein the first card is issued by a first state government, and the financial system is located in the territory of a second state government.

15. The financial system of claim 11 wherein the information corresponding to the bank account includes an account number previously presented, to a customer, on a paper statement generated by the financial institution managing the bank account.

16. The financial system of claim 15 wherein the financial institution is a bank.

17. The financial system of claim 11 wherein the plurality of cards are issued under authority of a government, each card evidencing a license for a person to operate a vehicle.

18. The financial system of claim 11 wherein the fee includes a non sufficient funds (NSF) fee allowable within state or federal statutes or regulations.

19. A financial system for a system having a payment switch and a retailer, the payment switch and the retailer being non-affiliated; a plurality of persons; a plurality of cards; a first signal corresponding to a signal common to the plurality of cards; a second signal on a first card in the plurality of cards, the financial system comprising:
means for receiving the second signal from a point of sale;
means for accessing a bank account, by using the first signal and the signal received by the means for receiving;
means, responsive to a failure to withdraw funds from the bank account, for accessing the bank account to withdraw an NSF fee; and
in an accounting system, means for making an entry corresponding to a first amount, the first amount being a portion of the fee owed by the owner of the payment switch to the retailer.
